(19) United States
(12) Patent Application Publication
(10) Pub. No.: US 2026/0146957 A1
(43) Pub. Date: May 28, 2026

(54) ANTI-ALIAISING FOR OPTICAL INSPECTION SYSTEM

(71) Applicant: Applied Materials Israel Ltd., Rehovot (IL)

(72) Inventor: Menachem LAPID, Hashmonaim (IL)

(21) Appl. No.: 19/399,597

(22) Filed: Nov. 24, 2025

(30) Foreign Application Priority Data
Nov. 24, 2024 (IL) 317226

(51) Int. Cl. G01N 21/88; G01N 21/956

(52) U.S. Cl. CPC G01N 21/8806; G01N 21/8851; G01N 21/956

(57) ABSTRACT

A wafer inspection tool including: an illumination system providing ultraviolet illumination light with wavelengths 2 below 300 nm and configured to direct light towards an object to be inspected; a detector array having a pixel pitch; one or more anti-aliasing (AA) elements; an objective having a numerical aperture (NA) and configured to collect light provided by the illumination system and returning from a plurality of field points on the object and to onwardly transmit a light beam formed from the returning light which has been collected towards the detector array via the one or more AA elements; a processor configured to: receive imaging requirements; control a NA of the objective; control, when the pixel pitch is larger than λ/(4*NA), position of the one or more anti-aliasing elements, based on the pixel pitch, the NA, and the imaging requirements.

### RELATED APPLICATIONS

This application claims the benefit of priority from Israeli Application No. 317226 filed on Nov. 24, 2024, which is incorporated herein by reference.

### TECHNOLOGICAL FIELD

The present disclosure, in some embodiments, thereof, relates to an optical inspection system and, more particularly, but not exclusively, to an optical inspection system having relatively large pixels with respect to a numerical aperture of the system.

### GENERAL DESCRIPTION

Following is a non-exclusive list of some exemplary embodiments of the disclosure. The present disclosure also includes embodiments which include fewer than all the features in an example and embodiments using features from multiple examples, even if not listed below.

Example 1. A wafer inspection tool comprising:
an illumination system providing ultraviolet illumination light with wavelengths λ below 300 nm and configured to direct light towards an object to be inspected;
a detector array having a pixel pitch;
one or more anti-aliasing (AA) elements;
an objective having a numerical aperture (NA) and configured to collect light provided by said illumination system and returning from a plurality of field points on the object and to onwardly transmit a light beam formed from the returning light which has been collected towards said detector array via said one or more AA elements;
a processor configured to:
   receive imaging requirements;
   control a NA of said objective;
control, when said pixel pitch is larger than λ/(4*NA), position of said one or more anti-aliasing elements, based on said pixel pitch, said NA, and said imaging requirements.

Example 2. The wafer inspection tool according to Example 1, wherein said objective comprises a plurality of optical elements mechanically supported by a turret and one or more actuators configured to position said optical elements;
wherein said processor is configured to control said NA of said objective by sending control signals to said one or more actuators to one or more of:
   selectively position one or more of said plurality of optical elements in an optical path of said objective; and
selectively position said one or more of said plurality of optical elements along said optical path of said objective.

Example 3. The wafer inspection tool according to any one of Examples 1-2, comprising one or more anti-aliasing AA element actuators, wherein said processor is configured to control position of said one or more AA elements by sending control signals to said one or more AA element actuators.

Example 4. The wafer inspection tool according to any one of Examples 1-3, wherein said control of position is of whether said one or more AA elements are in an optical path of said returning light.

Example 5. The wafer inspection tool according to any one of Examples 1-3, wherein said control of position is to move said one or more AA elements sufficiently rapidly with respect to an image exposure time that the movement provides image smear.

Example 6. The wafer inspection tool according to Example 5, wherein said one or more AA elements comprise one or more of said detector array, a platform supporting said object, and one or more optical element in an optical path of said returning light.

Example 7. The wafer inspection tool according to any one of Examples 1-4, wherein at least one of said one or more AA elements is positioned at a image plane of said returning light; and wherein said detector array is positioned behind said one or more anti-aliasing elements, at a defocusing distance from said image plane.

Example 8. The wafer inspection tool according to Example 7, wherein said one or more AA elements comprises a Damman grating.

Example 9. The wafer inspection tool according to Example 8, wherein said processor is configured to determine said defocusing distance by:
determining output of said Damman grating at far field, based on physical specifications of said Damman grating;
modeling near field behavior of the Damman grating, based on said output; and
selecting said defocusing distance, using said modeling and said imaging requirements.

Example 10. The wafer inspection tool according to any one of Examples 7-9, wherein said one or more AA elements comprises one or more savart plate.

Example 11. The wafer inspection tool according to any one of Examples 7-10, wherein said one or more AA elements comprises a fluorescent plate.

Example 12. The wafer inspection tool according to any one of Examples 1-11, wherein at least one of said one or more AA elements is positioned at a pupil of said wafer inspection tool.

Example 13. The wafer inspection tool according to Example 12, wherein said at least one AA element positioned at said pupil comprises a pupil divider configured to divide said returning light into portions having different delays.

Example 14. The wafer inspection tool according to any of Examples 12-13, wherein said at least one AA element positioned at said pupil comprises one or more of a savart plate, and a Wollaston prism.

Example 15. The wafer tool according to any one of Examples 1-14, wherein said processor is configured to:
control an effective pixel pitch of said detector array; and
control said position of said one or more anti-aliasing elements based on said effective pixel pitch.

Example 16. The wafer inspection tool according to any one of Examples 1-15, comprising an imaging lens arrangement configured to focus and direct said light beam towards said detector array.

Example 17. The wafer inspection tool according to any one of Examples 1-16, wherein said objective comprises at least one objective lens and a telescope.

Example 18. A method of wafer inspection comprising:
receiving a pixel pitch of a detector array of a wafer inspection tool and imaging requirements for inspection of an object;
selecting a numerical aperture (NA) of a wafer inspection tool by controlling one or more actuator of an objective of said wafer inspection tool;
controlling a position of one or more anti-aliasing (AA) element in an optical path of inspection light returning from said inspection object based on said pixel pitch, said NA, and said imaging requirements.

Example 19. The method according to Example 18, wherein said receiving said pixel pitch comprises controlling an effective pixel pitch of said detector array; and
wherein said controlling said position is based on said effective pixel pitch.

Example 20. A wafer inspection tool comprising:
an illumination system providing ultraviolet illumination light with wavelengths λ below 300 nm and configured to direct light towards an object to be inspected;
an objective configured to collect light provided by said illumination system and returning from a plurality of field points on the object and to onwardly transmit and focus a light beam formed from the returning light to a image plane;
a Dammann grating positioned at said image plane; and
a detector array having a pixel pitch and positioned a defocusing distance away from said image plane;
wherein a numerical aperture (NA) of said objective is less than λ/4 of an inverse of said pixel pitch of said detector array.

Unless otherwise defined, all technical and/or scientific terms used within this document have meaning as commonly understood by one of ordinary skill in the art/s to which the present disclosure pertains. Methods and/or materials similar or equivalent to those described herein can be used in the practice and/or testing of embodiments of the present disclosure, and exemplary methods and/or materials are described below. Regarding exemplary embodiments described below, the materials, methods, and examples are illustrative and are not intended to be necessarily limiting.

Some embodiments of the present disclosure are embodied as a system, method, or computer program product. For example, some embodiments of the present disclosure may take the form of an entirely hardware embodiment, an entirely software embodiment (including firmware, resident software, micro code, etc.) or an embodiment combining software and hardware aspects that may all generally be referred to herein as a “circuit,” “module” and/or “system.”

Implementation of the method and/or system of some embodiments of the present disclosure can involve performing and/or completing selected tasks manually, automatically, or a combination thereof. According to actual instrumentation and/or equipment of some embodiments of the method and/or system of the present disclosure, several selected tasks could be implemented by hardware, by software or by firmware and/or by a combination thereof, e.g., using an operating system.

For example, hardware for performing selected tasks according to some embodiments of the present disclosure could be implemented as a chip or a circuit. As software, selected tasks according to some embodiments of the present disclosure could be implemented as a plurality of software instructions being executed by a computational device e.g., using any suitable operating system.

In some embodiments, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage e.g., for storing instructions and/or data. Optionally, a network connection is provided as well. User interface/s e.g., display/s and/or user input device/s are optionally provided.

Some embodiments of the present disclosure may be described below with reference to flowchart illustrations and/or block diagrams. For example illustrating exemplary methods and/or apparatus (systems) and/or and computer program products according to embodiments of the present disclosure. It will be understood that each step of the flowchart illustrations and/or block of the block diagrams, and/or combinations of steps in the flowchart illustrations and/or blocks in the block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart steps and/or block diagram block or blocks.

These computer program instructions may also be stored in a computer readable medium that can direct a computer (e.g., in a memory, local and/or hosted at the cloud), other programmable data processing apparatus, or other devices to function in a particular manner, such that the instructions stored in the computer readable medium can be used to produce an article of manufacture including instructions which implement the function/act specified in the flowchart and/or block diagram block or blocks.

The computer program instructions may also be run by one or more computational device to cause a series of operational steps to be performed e.g., on the computational device, other programmable apparatus and/or other devices to produce a computer implemented process such that the instructions which execute provide processes for implementing the functions/acts specified in the flowchart and/or block diagram block or blocks.

Some of the methods described herein are generally designed only for use by a computer, and may not be feasible and/or practical for performing purely manually, by a human expert. A human expert who wanted to manually perform similar tasks, might be expected to use different methods, e.g., making use of expert knowledge and/or the pattern recognition capabilities of the human brain, potentially more efficient than manually going through the steps of the methods described herein.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A is a simplified schematic of an inspection system, according to some embodiments of the disclosure;

FIG. 1B is a simplified schematic of a portion of system, according to some embodiments of the disclosure;

FIG. 2 is a method of imaging for object inspection, according to some embodiments of the disclosure;

FIG. 3 is a method of imaging for object inspection, according to some embodiments of the disclosure;

FIG. 4 is a simplified schematic of an inspection system, according to some embodiments of the disclosure; and

FIG. 5 is a simplified schematic of a pupil divider 558, according to some embodiments of the disclosure.

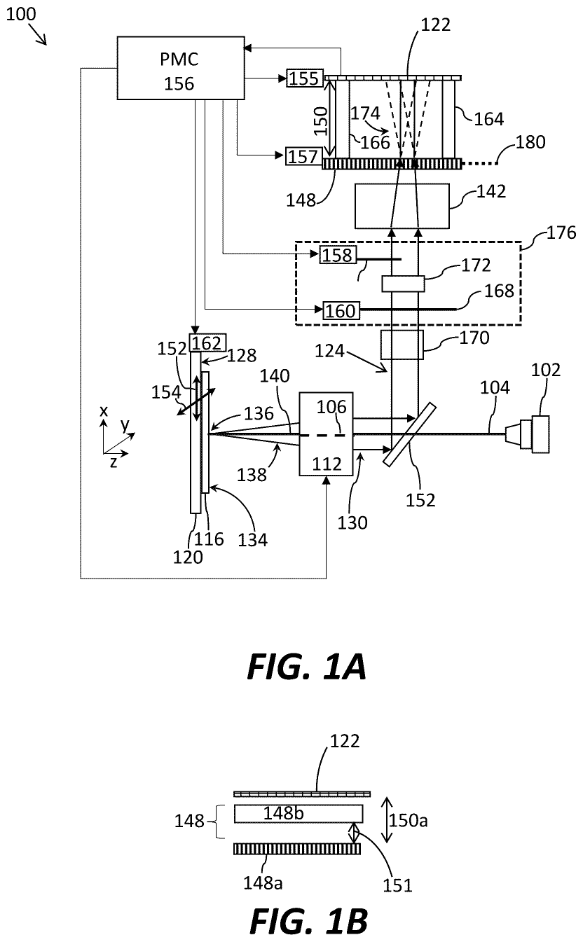

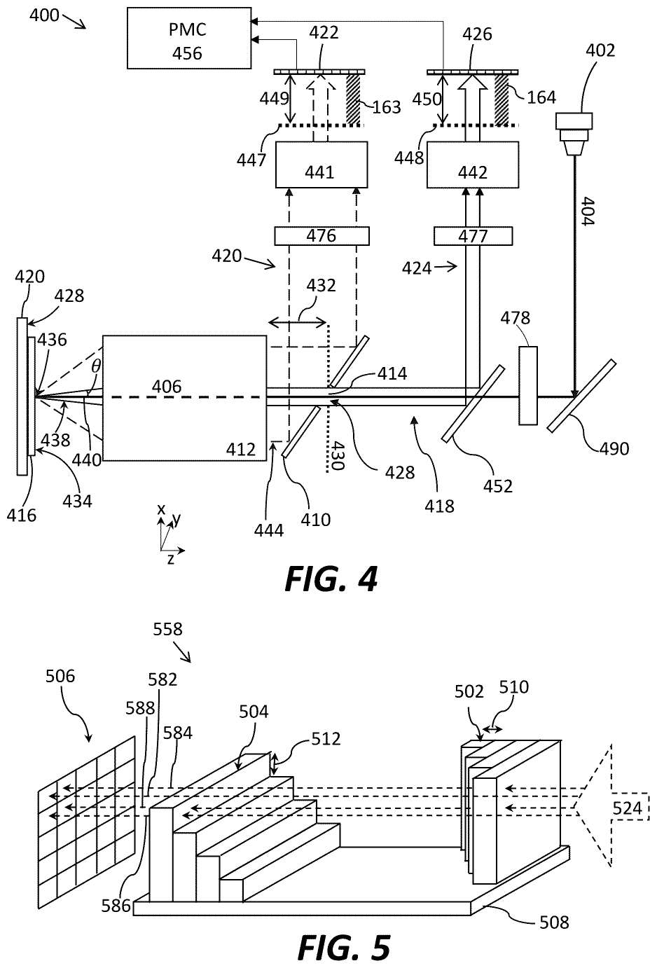

In some embodiments, although non-limiting, in different figures, like numerals are used to refer to like elements, for example, element 102 in FIG. 1 corresponding to element 402 in FIG. 4.

### DETAILED DESCRIPTION OF EMBODIMENTS

The present disclosure, in some embodiments, thereof, relates to an optical inspection system and, more particularly, but not exclusively, to an optical inspection system having relatively large pixels with respect to a numerical aperture of the system.

### Overview

A broad aspect of some embodiment of the disclosure relates to employing anti-aliasing technique/s to enable inspection (e.g., mask and/or wafer inspection) using an inspection apparatus having high numerical aperture (NA) and large field of view (FOV) which provides light to a minimal number of pixels, without reduction in light capture by the apparatus and/or scanning velocity (e.g., associated with wafter throughput for scanning type inspection systems) and/or signal to noise ratio (SNR) of the acquired image/s.

High NA potentially provides the ability to capture a large proportion of inspection light (e.g., to offer superior resolution), however, the image is mapped onto a finite number of pixels posing potential complications. When the FOV is large, systems can image more area simultaneously, which is potentially beneficial for efficiency but may introduce complications when the available pixel count is limited.

When the pixel size is large relative to the NA, there is a risk of aliasing. Aliasing occurs when high spatial frequency details are improperly sampled, resulting in artifacts that degrade the image quality. Anti-aliasing techniques can help mitigate this issue, but they don't inherently address the challenges posed by large FOVs combined with a limited number of pixels. Reducing the FOV while maintaining the same number of pixels can improve resolution and avoid aliasing, but this comes at the cost of covering less area, which compromises the system's efficiency.

A broad aspect of some embodiments of the disclosure relates to imaging for inspection (e.g., mask and/or wafer inspection) using anti-aliasing technique/s which enable use of systems having high numerical aperture (NA) collection and/or focusing apparatus (optionally also having large FOV) whilst using a detector array having relatively large pixels. For example, where the pixel pitch of the detector is larger than that required by the Nyquist-Shannon sampling theorem e.g., where pixel pitch p_{pitch} of the detector is larger than

$$\frac{λ}{4 NA} .$$

A potential advantage of a large NA is rapid imaging e.g., as the NA may be associated with high sensitivity meaning that sufficient information for inspection may be acquired during shorter exposures.

For example, for specified imaging requirements e.g., including a size of object feature/s to be inspected dₘᵢₙ. Where the NA and the wavelength of inspection light may be configured and/or selected so that the size of object feature/s to be inspected is suitable for a diffraction limited resolution of the system which, e.g., may be equal to the inspection light wavelength divided by double the

$${d}_{min} = \frac{λ}{2 NA} .$$

Where the Nyquist-Shannon sampling theorem may also be expressed as

$${p}_{pitch} \leq \frac{{d}_{min}}{2} .$$

In some embodiments, the inspection apparatus has a large NA and a large field of view (FOV).

In some embodiments, anti-aliasing techniques include one or more of the system including anti-aliasing element/s, where the elements may include optical anti-aliasing elements and/or actuator/s configured to perform anti-aliasing movement/s to system element/s, and anti-aliasing changes to detector hardware and/or software.

In some embodiments, the system includes a light source which illuminates an object to be inspected with inspection light, where light returning (scattered and/or reflected) from the object is directed and focused towards detector array which acquires images of the light to be used in the inspection process.

Although discussion herein may be regarding a single detector and anti-aliasing modifications to inspection light arriving at the single detector, it should be understood, than in some embodiments, the anti-aliasing technique/s described herein may be used in inspection systems having different darkfield (DF) and brightfield (BF) detectors. Where the DF and BF light paths may each include one or more anti-aliasing technique (where the techniques may be the same for both DF and BF light paths or different).

In some embodiments, one or more anti-aliasing element is positioned at one or more image plane of the device, the element/s herein termed a first anti-aliasing (AA) module. Where, the detector may then be displaced behind the first AA module (behind in the optical path of inspection light) at a defocusing separation from the first AA module. The positioning of first AA module and/or the detector may be fixed (e.g., spacer elements may hold the AA module and detector array in position) and/or have adjustable position where one or more actuator is configured to change the relative position of the first AA module and detector array. In some embodiments, the system only includes the first AA module, a potential benefit being anti-aliasing modification to inspection light without affecting other optics of the inspection tool (e.g., without affecting the objective). In some embodiments, the first AA module includes one or more of a grating (e.g., a Dammann grating), a fluorescence plate, and one or more savart plate.

In some embodiments, element/s of the first AA module are selectively positionable in the optical path of inspection light and/or within the optical path, e.g., providing an adjustable amount of anti-aliasing modification to inspection light which may be in accordance with (e.g., controlled according to) a system configuration (e.g., of a plurality of system configurations having different NA and/or pixel pitches).

Where, in some embodiments, an amount of AA modification is determined and/or selected by determining a spot size of inspection light, and introducing sufficient AA modification to ensure that a spread function (PSF) of a main lobe of the inspection light spans at least 4 pixels in both directions across the detector array. Where, in some embodiments, the spot size is determined by simulating physical propagation of beamlets, and summing thereof after interaction with AA module/s.

In some embodiments, for example, when implementing anti-aliasing technique/s in scanning-type inspection systems, a portion of AA modification is provided by enlarging the illumination spot. For example, where one or more AA element, e.g., a savart plate and/or a Dammann grating are positioned at an illumination intermediate plane, a plane which is imaged onto the wafer plane. Where the savart plate and/or Dammann grating are positioned to provide a defocus to provide a larger light spot for scanning the wafer e.g., without reducing the NA.

In some embodiments, one or more anti-aliasing element is positioned at a pupil (e.g., at an effective pupil) of the device, the element/s herein termed a second anti-aliasing (AA) module. Where one or more anti-aliasing element may be positioned at an entrance pupil and/or at an exit pupil of an object. The AA element/s at the exit pupil may include one or more of a savart plate, a Wollaston prism, and a pupil divider. The AA element/s at the entrance pupil may include one or more of a Wollaston prism, and a pupil divider.

In some embodiments, one or more element in an optical path is moved (e.g., at a rate which is high with respect to an imaging exposure time) to provide AA modification to light (e.g., associated with image smear introduced by the movement which is large with respect to the exposure time). In some embodiments, the inspection object itself is moved, and/or the detector is moved, and/or optical element/s.

In some embodiments, detector hardware itself is used to provide AA modification to light, for example, a detector array having low Modulation Transfer Function (MTF) at high spatial frequencies may be used and/or having high cross-talk and/or leakage between adjacent pixels. For example, a detector array where residual charge remains at pixels after pixel read out may be employed, the residual charge potentially acting to smear the image acquired.

Although discussion herein is generally concerning movement of AA module/s and/or element/s and/or an inspection object with respect to a light source it should be understood that the movement described should encompass relative movement between the light source and the AA module/s and/or element/s and/or inspection object. Where, in some embodiments, alternatively or additionally to movement of the AA module/s and/or element/s and/or inspection object the light source is moved e.g., by one or more actuator controlled by a system processor.

An aspect of some embodiments of the disclosure relates to an adjustable imaging system having adjustable NA and/or pixel pitch, were system configurations having large NA relative to the pixel pitch (e.g., pixel pitch is more than half the NA) are enabled by selectively employing anti-aliasing modification/s to inspection light and/or imaging hardware and/or software.

In some embodiments, the imaging system (also herein termed “inspection tool”) has more than one configuration associated with more than one NA and/or more than one configuration associated with more than one pixel size.

For example, in some embodiments, the system has more than one NA and/or has an adjustable NA. Where the inspection tool may be configured to provide different imaging modalities by selectively changing optical elements in optical path/s and/or the position/s thereof. In an exemplary embodiment, a turret hosts a plurality of optical elements and is configured to position selected optical elements in optical path/s of the inspection tool to form an objective lens arrangement having different NA depending on the selected optical elements. In some embodiments, selectable imaging modalities e.g., including different magnifications provides the ability to select sampling pixel pitch at the wafer.

For example, in some embodiments, the system is configured to use more than one detector, the detectors having different pixel pitch and/or is configured to provide one or more effective pixel pitch larger than the physical pixel pitch (e.g., by adding values of groups of adjacent pixels). However, it should be noted that increasing an effective pixel pitch may increase aliasing effects observed in acquired images.

An aspect of some embodiments of the disclosure relates to an inspection system where a Dammann grating is positioned at an image plane of the system, prior to a detector array in an optical path of light returning from an inspection object. Where the detector array may be separated from the Dammann grating by a de-focusing distance which is selected based on optical characteristics of the Dammann grating and an amount of anti-aliasing modification required, for example, in a direction of the light path (e.g., according to the NA and pixel pitch and optionally anti-aliasing modification provided by other system element/s). In some embodiments, characteristics of the Dammann grating are selected to provide a desired amount of anti-aliasing modification in directions perpendicular to the direction of the light path (e.g., where the light path of light meeting the Damman grating is designated as the z direction.

Dammann grating characteristic/s may be selected to provide desired anti-aliasing modification in the x and/or y directions). Where the Dammann grating characteristics may include a number of active diffraction orders, which diffraction orders are active, diffraction angle between active orders, and proportion of light intensity distributed to each diffraction order.

In an exemplary embodiment, the Dammann grating is a two dimensional grating e.g., providing anti-aliasing modification to light received to the grating in both x and y directions.

Potential advantages of Dammann gratings include extended lifetime under UV (ultraviolet) light, low noise levels, low magnification distortion, and insensitivity to polarization of light and/or tilted direction thereof.

In some embodiments, the Dammann grating is designed for use with asymmetrical requirements, for example, where one or more of, detector pixels do not have equal dimensions in both x and y directions (e.g., are rectangular) and AA modification requirements are different in different directions. Where, in some embodiments, the Dammann grating may have different characteristics in different directions, for example, number of diffraction orders.

Without wanting to be bound by theory it is theorized that the Dammann grating provides anti-aliasing modification to the inspection light by diffracting received light with intensity distributions over multiple diffraction orders, creating uniform spot arrays in the far field. It is theorized that this design inherently favors the transmission of lower spatial frequencies, corresponding to broader, more uniform parts of the beam, over higher spatial frequencies, which correspond to rapid spatial variations within the beam. As the Dammann grating diffracts light, it is theorized that the light energy is redistributed across the desired diffraction orders diffusing the energy associated with higher spatial frequencies over a wider area, reducing their relative intensity in the diffracted beams. The outputted beam may have a lower proportion of high spatial frequencies compared to low spatial frequencies, potentially resulting in acquired images having lower aliasing effects.

In some embodiments, a position of the Dammann grating with respect to the detector array is adjustable e.g., by one or more actuator. In some embodiments, position of the Dammann grating is determined based on anti-aliasing requirements for example, of a system configuration e.g., where the system has a plurality of configurations. Where NA and/or pixel size may be used along with the Dammann grating's optical properties to determine the position.

In some embodiments, an existing imaging system is retrofitted to provide extended functionality with regards to imaging by incorporation of one or more element to and/or adjustment/s made to the optical system to reduce aliasing effects in images acquired with the system.

For example, in some embodiments, one or more of the anti-aliasing elements described herein are employed (e.g., a Dammann grating is positioned at the image plane) to replace an image intensifier (II), e.g., an image intensifier tube (IIT). Where the IIT may include a photocathode tube. For example, where the system may lack an IIT and/or where, if retrofitting is performed to an existing system, a system IIT is removed or the optical path is directed around the IIT and e.g., the Dammann grating is installed to the system.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

FIG. 1A is a simplified schematic of an inspection system 100 according to some embodiments of the disclosure.

FIG. 1B is a simplified schematic of a portion of system 100, according to some embodiments of the disclosure.

In some embodiments, inspection system 100 is a semiconductor wafer and/or mask inspection system, for example, used to inspect one or more of defects, particles, and patterns on a surface e.g. a surface of an object and/or specimen 116 for inspection (hereinafter termed “object”, also termed “substrate”) e.g. as part of a quality assurance process in a semiconductor manufacturing processes.

Inspection system 100, in some embodiments, includes a platform 120 for receiving and/or securing object 116. Platform 120, in some embodiments, is stationary or, in some embodiments, is a moveable stage:

For example, in some embodiments, platform 120 is configured to move in a longitudinal direction (along and/or in a same direction as an optical axis 106 (parallel to a z-axis) of an objective lens arrangement 112 (which is described hereinbelow) and/or in one or both transverse directions 152, 154 (x- and/or y-axis of FIG. 1A) e.g. in the same plane as a top surface 128 of platform 120. In some embodiments, movements of platform 120 are provided by one or more actuator 162 which may move platform 120 according to control signals received from a processing and memory circuitry (PMC) 156.

In some embodiments, inspection system 100 includes a light source 102 for illuminating object 116. In some embodiments, light source 102 is a single point source (e.g. a laser) that illuminates a single point on the object. In some embodiments, platform 120 is configured to move in coordination with scanning sequence for light source 102 e.g. to enable object 116 placed on platform 120 to be scanned by the light source 102. In some embodiments, light source 102 includes an array of point sources that illuminate multiple points on the object simultaneously (e.g. to make system 100 capable of collecting information from multiple locations on the object simultaneously). In some embodiments, light source 102 includes an aerial illumination source which illuminates a continuous area. In some embodiments, at least a portion of light 104 provided by light source 102 arrives to illuminate object 116.

In some embodiments, light reflected off a point 136 on object 116 may be regarded as forming a cone 138 originating from point 136 with a chief ray 140 (also herein termed “centroid ray” and “central axis” of the reflected light from point 136) perpendicular to the surface of the object and forming a central axis of cone 138.

In some embodiments, inspection system 100 includes an imaging lens or imaging lens arrangement 1Δ1, hereinafter termed “imaging lens arrangement”, where this term should be understood to include an imaging lens as well as an imaging lens arrangement.

In some embodiments, system 100 includes a light detector apparatus 122 (also herein termed “detector array”) disposed behind imaging lens arrangement 141 (behind, in an optical path of light 124 returning from object 116). Where, in some embodiments, detector apparatus 122 detects an image formed by imaging lens arrangement 142. In some embodiments, detector array 122 includes a pixelated optical detector e.g., includes a focal plane array (FPA). A plurality of pixels of detector array 122 may have a same size, the pixels having a pixel pitch. In some embodiments, FPA 122 includes a Charge-Coupled Device (CCD).

In some embodiments, signal/s (e.g., image/s) from detector array 122 are sent to PMC 156 e.g., for display to a user e.g., for further processing and/or storage in memory.

Imaging lens arrangement 141 and detector apparatus 122, in some embodiments, are arranged off optical axis 106 of the objective lens arrangement 112 e.g. through the use of a partially reflective element 152 that is transmissive on one side to allow transmission of light from the light source 102 while reflective on the opposite side to reflect light signal 120 towards detector array 122.

It should be understood that illustrated positioning of imaging lens arrangement 141 and/or detector apparatus 122 and/or light source 102 on or off-axis to optical axis 106 of the objective lens arrangement 112 are optional and not essential to the present technology.

In some embodiments, inspection system 100 includes an objective lens arrangement 112 also herein termed “objective”. Where objective lens arrangement may include a plurality of optical elements including, for example, at least an objective lens and a telescope.

In some embodiments, objective lens arrangement 112 collects and transfers (e.g., focusing and/or otherwise modifying) light 104 originating from light source 102 to object 116. Objective lens arrangement 112 may receive light returning (e.g. reflected and/or scattered) from object 116 e.g., directing the returning light 120 along an optical path towards detector 122. In some embodiments, objective lens arrangement 112 is arranged to receive and collect light reflected from a plurality of field points on object 116 (e.g. light from the light source 102 reflected and/or scattered off a portion of the object, or transmitted through a portion of the object as in the case of a transmission microscope). In some embodiments, objective lens arrangement 112 is configured for telecentric imaging at the object side.

In some embodiments, system 100 optical elements in an optical path of light 138 returning from object 116 have a NA (e.g., the optical elements including objective 112 and imaging lens arrangement 141).

In some embodiments, system 100 is configured for multiple imaging modalities. Where different imaging modalities may be implemented using different configurations of objective lens arrangement 112.

For example, in some embodiments, objective 112 is provided by a turret hosting a plurality of optical elements where, for example, the plurality of optical elements may include multiple objective lenses, each e.g., with different magnification levels and/or optical properties. In some embodiments, optical elements of the plurality of turret optical elements are positioned (e.g., into optical path/s and/or spatially) to provide objectives with different optical properties for different imaging modalities. In some embodiments, positioning of the optical elements of the turret (e.g., to provide different objectives) is automated. Where, for example, one or more actuator (not illustrated) receiving control signals regarding a selected imaging modality from a processing and memory circuitry (PMC) 158 positions optical element/s to configure objective 112 for the selected imaging modality.

In some embodiments, objective lens arrangement 112 is configured (e.g., element/s of the objective lens arrangement 112 are selected and/or arranged and/or aligned) such that light collected by the objective lens arrangement 112 from any given field point 136 on object 134 exits the objective lens arrangement 112, passing through an exit pupil 130 (position of pupil 130 along axis 106 illustrated in FIG. 1A as a dotted line), e.g., as parallel rays that are imaged at infinity.

In some embodiments, system optical elements, e.g., objective 112 and/or imaging lens arrangement 141 focus light 138, 124 returning from object 116 to a image plane 180.

In some embodiments, system 100 includes one or more anti-aliasing (AA) element. For example, one or both of a first anti-aliasing (AA) module 148 and a second anti-aliasing (AA) module 176.

In some embodiments, first AA module 148 includes one or more element positioned at image plane 180. Although a single location is illustrated for first AA module 148 and image plane 180 it should be understood that one or more element of first AA module 148 may be positioned at virtual image plane/s elsewhere in the system e.g., as provided by relay/s (not illustrated).

As AA module 148 is positioned at image plane 180, detector array 122 may then be positioned (e.g., repositioned if first AA module 148 is added to an existing system, or if the grating is selectively positioned in an optical path of light 124) a defocusing distance 150 away from first AA module 148 (and from image plane 180).

Optionally, for example, in embodiments where the first AA module 148 is fixed in position, one or more spacer element 164, 166 may be used to position detector array 122 and/or first AA module 148 at the desired separation of defocusing distance 150. In some embodiments, defocusing distance 150 is determined based on characteristics of first AA module 148 and optionally, other optical elements of system. In some embodiments, for example, where AA module includes a Dammann grating, defocusing distance is 20-70 microns.

Optionally, one or both of detector array 122 and first AA module 148 are adjustably positionable. System 100 including one or more of actuators 155, 157 configured to position detector array 122 and/or first AA module 148 respectively, e.g., based on control signals received from PMC 158. Where, for example, first AA module grating 148 may be selectively positioned into an optical path of light 124 e.g., according to anti-aliasing requirements of a system imaging modality. For example, the detector array being positionable at the image plane e.g., where the first AA module is not used during imaging. Where, for example, position of first AA module 148 may be adjusted according to changes in the image plane according to different imaging modalities. Where, a separation between first AA module 148 and detector array 122 may be adjustable. In some embodiments, positioning is changed by one or more actuator 155, 157 which may receive control signal/s from PMC 157. In some embodiments, actuator/s 155, 157 are configured to change dimension/s and/or move one or more spacer 164, 166.

In an exemplary embodiment, first AA module 148 is and/or includes a grating which, in an exemplary embodiment, is a Dammann grating. In some embodiments, the only element of first AA module 148 and/or the only AA system element is a Dammann grating (positioned at image plane 180).

In some embodiments, one or more Dammann grating characteristics are selected to provide desired AA modification to light received by Dammann grating. Where the Dammann grating characteristic/s may include one or more of; a number of active diffraction orders a number of active diffraction orders, which diffraction orders are active, diffraction angle between active orders, and proportion of light intensity distributed to each diffraction order.

In some embodiments, Dammann grating 148 includes 7-20 active orders in each of the x and y directions, corresponding to between 7×7 and 20×20 orders.

In an exemplary embodiment, Dammann grating 148 includes 15×15 orders, where order spacing is equal in x and y direction. Where a proportion of light intensity directed to each order may be selected/defined and/or a proportion of the light intensity which is permitted for higher orders.

In some embodiments, a periodicity of the Dammann grating pattern, d, is 2-10 microns. Where the periodic pattern of the Dammann grating may be associated with distance between orders. The periodicity and/or associated distance between orders providing diffraction angles between orders for wavelengths of received length. For example, according to θ=λ/d, where θ is the diffraction angle for light of wavelength 2 and distance between orders d.

In an exemplary embodiment, d is about 2 microns, where details within cells of the Dammann grating had a period of 200 nm. In some embodiments, separation distance 150 and/or dimension/s of spacer/s 164, 166 are determined by modelling behavior of the Dammann grating and determining separation distance 150 based on the Dammann grating behavior and anti-aliasing requirements. In some embodiments, Dammann grating behavior at far field is known (e.g., is provided by supplier and/or manufacturer of the grating along with the grating e.g. where the “known” behavior is of the particular Dammann grating at infinity) where, in some embodiments, it is near field behavior of the Damman grating which is used to determine the separation distance. The near field behavior determined, for example, using the known far field behavior. Where, for example, determining may include simulations of how light beamlets combine and/or appear close after passing through the Damman grating.

In some embodiments, Dammann grating has adjustable position e.g., where system 100 includes one or more actuator 157 configured to control position of Dammann grating 148. In some embodiments, separation 150 between grating 148 and detector 122 is adjustable, for example, to provide adjustable AA modification to light e.g., for different system configurations (e.g., adjustable NA and/or pixel size) and/or imaging requirements. Where, for example, in some embodiments, one or more actuator 155, 157 is configured to adjust separation 150 e.g., by moving detector 122 and/or grating 148 respectively.

In some embodiments, for example, alternatively or additionally to first AA module 148 including a Dammann grating, first AA module 148 includes a fluorescence plate. Without wanting to be bound by theory, it is theorized that when light with high spatial frequency variations (sharp edges or fine patterns) illuminates a fluorescence plate, the fluorescent material absorbs this light and re-emits it at a longer wavelength/s. This re-emission process may spread the light more uniformly over a larger area, potentially smoothing out the fine details and high-frequency variations potentially providing anti-aliasing modification to the light.

In some embodiments, for example, alternatively or additionally to first AA module 148 including a Dammann grating and/or fluorescence plate, first AA module 148 includes a savart plate 168. Where savart plate 168 (or a plurality of savart plates 158) may be positioned at or near the image plane 180. Without wanting to be bound by theory, it is theorized that when non-polarized light passes through savart plate 168, it splits into two orthogonally polarized components that travel with different velocities, causing an interference pattern which may selectively attenuates high-frequency spatial components of the light potentially providing anti-aliasing modification to the light. Without wanting to be bound by theory, it is theorized that an amount of AA modification (e.g., the image smear) provided by savart plates is associated with a thickness of the Savart plate and the birefringence of the material of the plate.

In some embodiments, for example, where the inspection light 124 is partially polarized, a plurality of savart plates (e.g., as a layered element) are employed in first AA module 148, where different savart plates of the plurality of savart plates are rotated about the optical axis with respect to each other.

In some embodiments, one or more of; a number of savart plates, a thickness of each savart plate, birefringence of the material of the savart plate are selected to provide a desired AA modification (e.g., image smear associated with the savart plates). Optionally, in some embodiments, one or more actuator 157 is configured to selectively position one or more element of first AA module 148 in an optical path of light 124 and/or to position the element/s along the optical path e.g., to provide (e.g., collectively where more than one element is positioned in the optical path) required AA modification to light for the particular (e.g., selected) system configuration and/or imaging requirements.

Referring now to FIG. 1B, in some embodiments, first anti-aliasing (AA) module 148 includes both a grating 148a (e.g., Dammann grating) and a fluorescence plate 148b. Where grating 138a and fluorescence plate 148b may be separated by a distance 151. In some embodiments, grating 148a is separated from detector 122 by a distance 150a.

Returning now to FIG. 1A, in some embodiments, second AA module 176 includes one or more anti-aliasing element configured to provide at least a portion of anti-aliasing modification to returning light 138, 124. In some embodiments, second AA module 176 is positioned at an effective pupil of system 100. Where the effective pupil may correspond to exit pupil 130 which has been relayed (e.g., by optical element/s not illustrated in FIG. 1A) to a location of second AA module 176.

In some embodiments, second AA module 176 includes one or more of a savart plate 268, a Wollaston prism 172, and a pupil divider 258.

In some embodiments, savart plate/s may be employed at exit pupil 130 where characteristic/s of the savart plate are selected to provide a desired angularly effect on received light (e.g., as opposed to lateral displacement characteristics e.g. when used in first AA module 148).

Wollaston prism 172 splits received light into two orthogonally polarized beams that diverge at an angle dependent on the wavelength and the birefringent (refractive indexes in different directions are different) properties of prism 172. Without wanting to be bound by theory, it is theorized that this divergence may acts as a form of angular separation for spatial frequencies which may be used to filter out higher spatial frequencies.

Pupil divider 258, in some embodiments, is a device which provides different optical paths for different portions of received light beam 124. Where a difference in the optical paths is longer than a coherence length of the light (e.g., coherence length of the illumination light 104 from source 102). The length being larger than the coherence length providing outputted portions of beam 124 which are not coherent. Pupil divider 158 may provide two or more optical paths. In some two-path embodiments, a window 158 of material may be placed intercepting a portion of beam 124. FIG. 5 illustrates an exemplary implementation of a 25 path embodiment.

Optionally, in some embodiments, system 100 includes an image intensifier or image intensifier tube 170 (herein after termed “IIT”). In some embodiments, IIT 170 provides a portion of anti-aliasing modification to light 124. However, in some embodiments, other AA element/s replace an IIT e.g., where a system is retrofitted with additional AA elements.

Optionally, in some embodiments, system 100 includes a multi-channel plate (MCP) where the MCP may be used for amplification of received light signal/s.

In some embodiments, one or more AA element is positioned at an entrance pupil to objective 112 (not illustrated). For example, one or more of a Wollaston prism, and a pupil divider.

Alternatively or additionally, to employing AA element/s, anti-aliasing movement/s of system element/s may be performed. Where one or more actuator (e.g., receiving control signals from PMC 156) is configured to move one or more element of system to adjust the detected inspection light signal which is detected at detector 122. The element/s moved interact with inspection light, for example, the movement being configured (e.g., sufficiently fast with respect to an image acquisition time) to provide smear to the acquired image at detector 122. Where, smear the image may be sufficiently smeared to reduce high spatial frequencies in the image and potentially thereby reduce aliasing effects in the image.

In scanning system embodiments (e.g., where the light source and inspection object are moved in coordination with a scanning sequence) movement/s of one or both objects may be adjusted to provide image smear for reduction of high spatial frequencies in the image. For example, where movement/s of one or both of the light source and inspection object are moved slightly asynchronously to provide image smear.

In some embodiments, one or more element in the optical path of light 138, 124 is moved, for example, where one or more mirror and/or lens and/or prism, and/or fast polygon, and/or electro-optic deflector are moved (e.g., by actuator/s) to provide anti-aliasing smear to the light.

In some embodiments, at least a portion of anti-aliasing modification to returning light 138, 124 may be provided by movement of inspection object 116. This movement may be implemented by movement of support 120, where the movement is configured to be sufficiently fast with respect to acquisition time of detector 122 to produce a smearing effect to image/s acquired of returning light 138. In some embodiments, movement is in one or more direction 152, 154 perpendicular to objective optical axis 106.

In some embodiments, one or more actuator 155 is configured to move detector 122 to provide anti-aliasing smear to the detected image.

Alternatively or additionally to employing AA element/s and/or movement/s, in some embodiments, detector 122 hardware and/or software provides anti-aliasing modification to detection image/s.

For example, in some embodiments, at least a portion of anti-aliasing modification is provided by FPA detector 122 (where FPA detector 122 may be a CCD detector). Where, in some embodiments, FPA detector 122 is selected to have a low inherent modulation transfer function MTF for high spatial frequencies and/or high cross talk between adjacent pixels. In some embodiments, the FPA detector pixels are hosted by a thick silicon substrate which increases electron spatial diffusion between adjacent pixels after detection and prior to reading of the pixel values. In some embodiments, FPA detector 122 is configured to hold residual image charge at pixels which may result in image smearing potentially providing anti-aliasing modification to the acquired image/s.

In scanning system embodiments, a portion of AA modification may be provided by enlarging the illumination spot. For example, where one or more AA element, e.g., a savart plate and/or a Dammann grating are positioned at an illumination intermediate plane (not illustrated), a plane which is imaged onto the wafer plane. Where the plane may be located on the illumination path between light source 102 and objective 112. Where the savart plate and/or Dammann grating are positioned to provide a defocus to provide a larger light spot for scanning the wafer e.g., without reducing the NA.

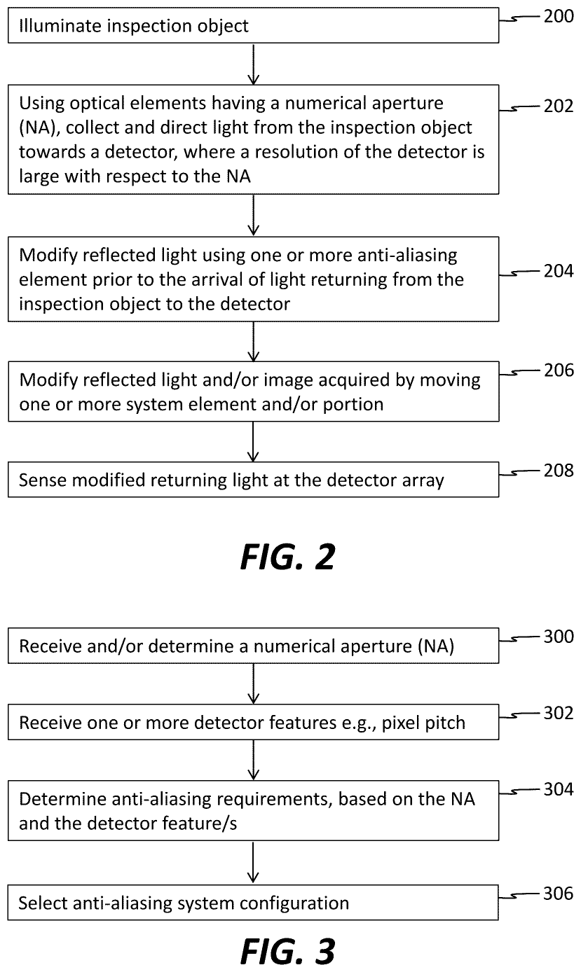

FIG. 2 is a method of imaging for object inspection, according to some embodiments of the disclosure.

At 200, in some embodiments, an inspection object (e.g., object 116 FIG. 1) is illuminated. For example, by a light source e.g., 102. Where illumination light may be modified by one or more optical component before arriving to illuminate the inspection object.

At 202, in some embodiments, illumination light returning from the inspection object (e.g., reflected from and/or scattered by the inspection object) is collected and directed on an optical path towards a detector. In some embodiments, the optical elements collecting and directing the light returning from the inspection object have NA which is large with respect to a pixel pitch of the detector. For example, where the detector is a pixelated detector array having a pixel pitch p which is more than λ/(4NA) where A is a wavelength of the inspection light, where the NA is larger than λ/(4p).

In some embodiments, pixel pitch is 2-100 microns, or 2-20 microns, or about 4 microns, or lower or higher or intermediate ranges or pitches. In some embodiments, wavelength of inspection light is 0.2-0.4 microns or about 0.3 microns (300 nm) or lower or higher or intermediate ranges or wavelengths. In some embodiments, the NA of the system is 0.075-0.0015. At 204, in some embodiments, light returning from the inspection object, is modified, prior to its arrival at the detector.

Where, in some embodiments, at least part of the anti-aliasing modification of the light is provided by one or more anti-aliasing element e.g., first AA module 148 and/or second AA module 176.

At 206, in some embodiments, the reflected light and/or the image acquired are modified by controlled movement of one or more system element and/or portion. For example, by movement of object 116 (e.g., via movement of platform 120 FIG. 1) and/or of detector 122 and/or one or more element as described regarding movement of objects to provide blur in the description of FIG. 2. Where the movement may be sufficiently rapid, for example, at a rate larger than the detector acquisition time also herein termed “exposure time”. Optionally, exposure time may be increased when movement is used to provide smear.

At 208, in some embodiments, the modified returning light is sensed at one or more detector array. Where the light image/s acquired by the detector may have reduced aliasing effects than would be present without the anti-aliasing modification/s performed at step 204 and/or step 206.

FIG. 3 is a method of imaging for object inspection, according to some embodiments of the disclosure.

At 300, in some embodiments, a NA of an inspection system is received. In some embodiments, the NA is that of a configuration and/or modality of the system. Where, for example, the system may have a plurality of configurations corresponding to a plurality of imaging modalities. In some embodiments, system configuration and/or modality feature/s are received and the NA of the system is determined from the feature/s.

At 302, in some embodiments, one or more detector feature is received. For example, a detector pixel pitch. In some embodiments, the received pixel pitch is an effective pixel pitch e.g., where pixel values are added at the detector to provide effective pixels which are larger than the physical size of the pixels of the array.

In some embodiments, received detector feature/s include those which affect image smear, for example, MTF characteristics of the detector, levels of pixel leakage and/or cross-talk, and residual charge at pixels.

At 304, in some embodiments, based on one or more of the NA, a minimal object feature size to be captured dₘᵢₙ, and the detector feature/s (e.g., including detector pixel pitch p_{pitch}), anti-aliasing requirements are determined.

For example, where anti-aliasing requirements may be associated with (e.g., determined) from acceptable levels of imaging noise. For example as light energy at spatial frequencies higher than the Nyquist frequency associated with the pixel side may contribute to noise levels (e.g., aliasing noise).

Where anti-aliasing requirements may be associated with a size of features to be detected on the inspection object. At 306, in some embodiments, based on the anti-aliasing requirements, an anti-aliasing system configuration is selected. Where the configuration may include which anti-aliasing elements of the system are positioned in an optical path of the inspection system and/or their position (e.g., by movement of one or both of the AA elements and the illumination source). In some embodiments, a single anti-aliasing element is employed (for example, a Dammann grating e.g., as described regarding FIG. 1). In some embodiments, a plurality of anti-aliasing elements are employed, where each of the elements contributes a part of the anti-aliasing requirements e.g., as determined in step 304.

FIG. 4 is a simplified schematic of an inspection system 400, according to some embodiments of the disclosure.

In some embodiments, inspection system 400 includes one or more feature of inspection system 100 FIG. 1A. Where, for example, one or more of an objective Δ12, a platform Δ20 configured to host an inspection object Δ16, returning light 438, a light source 402, light 404, a PMC 456 may include feature/s of like numbered elements of FIG. 1A. For example, where one or more of: objective Δ12 corresponds to objective 112 FIG. 1A, platform Δ20 corresponds to platform 120 FIG. 1A, inspection object Δ16 corresponds to inspection object 116 FIG. 1A, light source 402 corresponds to light source 102 FIG. 1A, light 404 corresponds to light 404 FIG. 1A.

In some embodiments, system 400 includes both dark field (DF) and bright field (BF) imaging modalities. System 400 including both a DF detector array Δ22 and a BF detector array Δ26. Where array/s Δ22, Δ26 may include feature/s of detector array 122 FIG. 1A. In some embodiments, system 400 includes both BF and grey field (GF) imaging modalities, where GF may be understood to be an intermediate technique where light captured is not entirely direct (as in BF) but also not entirely scattered (as in DF). In some embodiments, the “DF” detection apparatus (e.g., including detector array Δ22) as described herein is a GF detection apparatus.

Optionally, in some embodiments, system 400 includes one or more reflector. For example, a reflector 490 positioned along optical axis 406 of the objective lens arrangement Δ12 to direct light beam 404 or multiple light beams from light source 402 (through objective lens arrangement Δ12) towards the platform Δ20. Reflector 490, in some embodiments, enables light source 402 to be placed off optical axis 406 of the objective lens arrangement Δ12, for example, to reduce a size of system 400.

In some embodiments, light reflected off a point 436 on object Δ16 may be regarded as forming a cone 438 originating from the point with a chief ray 440 (also herein termed “centroid ray” and “central axis” of the reflected light from point 436) perpendicular to the surface of object Δ16 and forming a central axis of cone 438.

In some embodiments, such a light cone 438 is characterized by a half angle θ defined with respect to central axis 440. In some embodiments, light within cone 438 is considered to be bright field (BF) light. Where, in the BF light signal, in some embodiments, uneven features of surface 434 of the object appear as dark features against a light background.

In some embodiments, light outside of cone 438, i.e. coming off the point 436 at an angle greater than 0 with respect to chief ray 440, is regarded as scattered light also herein termed “dark field (DF) light” or “DF light signal” which does not contain BF light or specular rays. Where, for example, DF light includes light scattered by uneven features, e.g. such as defects and/or particles, e.g. on the surface 434 of object Δ16.

In some embodiments, system 400 includes a light signal separator Δ10 (also herein termed “separator”) to separate DF light signal Δ20 from BF light signal Δ24. (e.g. for separate detection thereof by a BF detector apparatus Δ22 and a DF detector apparatus 426). Where, in some embodiments, separator Δ10 allows therethrough (e.g., through a hole and/or transmissive region) a central portion of light beam Δ18 while a peripheral portion of the light beam 444 is reflected in a different direction by a reflective surface of light signal separator Δ10.

Other embodiments for separation of DF and BF light signals are also envisioned and encompassed. For example, where a separator separates between a peripheral ring of illumination BF and allows therethrough a central beam of DF light.

In some embodiments, inspection system 400 includes two imaging lenses or imaging lens arrangements 4Δ1, 442, which are hereinafter termed “imaging lens arrangement”, where this term should be understood to include an imaging lens as well as an imaging lens arrangement. In some embodiments, one or both of imaging lens arrangements 4Δ1, 442 include one or more feature as described and/or illustrated regarding imaging lens arrangement 142 FIG. 1A.

In some embodiments, system 400 includes two light detectors apparatuses Δ22, 426, each of which are respectively disposed behind (in optical paths of BF Δ24 and DF light Δ20) an associated imaging lens arrangement 4Δ1, 442. Where, in some embodiments, detector apparatuses Δ22, Δ26 each detect an image formed by the respective imaging lens arrangements 4Δ1, 442. In some embodiments, detector arrays 422, Δ26 each include a pixelated optical detector e.g., having feature/s of detector array 122 FIG. 1A.

In some embodiments, light signal separator/divider Δ10 is disposed at an angle (i.e. tilted) with respect to optical axis 406 of the objective lens arrangement Δ12. For example, such that the peripheral portion 444 of the light (DF signal) is directed off the illumination optical axis 406, for example, enabling imaging lens arrangement 441 and DF detector apparatus Δ22 to be arranged off the optical axis.

Imaging lens arrangement 442 and corresponding detector apparatus Δ26, in some embodiments, are arranged off optical axis 406 of the objective lens arrangement Δ12, for example, through the use of e.g. a partially reflective element 452 (which may include one or more feature of element 152 FIG. 1A) that is transmissive on one side to allow transmission of light from the light source 402 while reflective on the opposite side to reflect BF signal Δ24 towards the BF detector array Δ26.

It should be understood that illustrated positioning of the imaging lens arrangements 4Δ1, 442 and/or detector apparatuses Δ22, Δ26 and/or light source 402 off-axis to optical axis 406 of the objective lens arrangement Δ12 is optional and not essential to the present technology.

In some embodiments, objective lens arrangement Δ12 includes, for example, a plurality of optical elements e.g. including an objective lens and a telescope. Where objective lens arrangement Δ12, in some embodiments, receives and transfers light originating from light source 402 to object Δ16 and receives light returning (e.g. reflected and/or scattered e.g. BF signal and/or DF signal light) from object and transfers the returning light to separator Δ10.

In some embodiments, objective lens arrangement Δ12 is arranged to receive and collect light reflected from a plurality of field points on object Δ16 (e.g. light from the light source 402 reflected and/or scattered off a portion of the object, or transmitted through a portion of the object as in the case of a transmission microscope) and configured, in the present embodiment, for telecentric imaging at the object side.

In some embodiments, objective lens arrangement Δ12 is configured (e.g. element/s of the objective lens arrangement Δ12 are selected and/or arranged and/or aligned) such that light collected by the objective lens arrangement Δ12 from any given field point 436 on object 434 exits the objective lens arrangement Δ12, passing through an exit pupil 430 (illustrated as two dotted lines in FIG. 4), as parallel rays that are imaged at infinity.

In some embodiments (e.g. to maximize correct separation of BF and DF light by the separator) exit pupil 430 of objective lens arrangement Δ12 is positioned at window 428 of separator.

The light signal separator/divider Δ10, in some embodiments, is positioned at the exit pupil 430 and arranged so window Δ28 of the separator Δ10 coincides with the objective exit pupil 430, laterally and axially. In other words, the system, in some embodiments, is theoretically configured such that an entrance pupil of the objective lens arrangement matches the exit pupil of the objective lens arrangement and the back image plane of the objective lens arrangement.

In some embodiments (e.g. to maximize a proportion of illumination light which passes through separator to objective lens arrangement e.g. while maximizing accurate separation of DF and BF light) source illumination 404 is focused to a region of window 428 and/or to pupil 430 of objective lens arrangement. Where, in some embodiments, an illumination system including light source 402, relay module 478 (and optional reflector 490) form an afocal beam at an exit pupil thereof Δ14. The exit pupil Δ14 of the illumination system, in some embodiments, is matched to an entrance pupil of the objective lens arrangement. For example, by selection and/or alignment of relay module 478 elements.

In some embodiments, objective lens arrangement Δ12 has an optical axis 406, in FIG. 4 parallel to a z-axis. In some embodiments, optical axis 406 is perpendicular to a plane in which a top surface Δ28 of platform Δ20 extends.

In some embodiments, separator Δ10 window Δ28 is positioned at or near (i.e. contiguous) exit pupil 430 of objective lens arrangement Δ12 (i.e. a theoretical position thereof e.g. determined using feature/s of optical elements of objective lens arrangement 412).

In some embodiments, anti-aliasing modification/s are performed on one or both of BF light Δ24 and DF light Δ20. Where, for example, system 400 may include one or both of a BF first AA module 447 and DF first AA module 448, each having one or more feature as described and/or illustrated regarding first AA module 148 FIGS. 1A-B. Where, for example, system 400 may include one or both of a BF second AA module 476 and DF second AA module 477, each having one or more feature as described and/or illustrated regarding second AA module 176 FIG. 1A.

In some embodiments, first AA modules 447, 447 and/or second AA modules 476, 477 may be the same. In some embodiments, they may differ, for example, where DF first and/or second modules 447, 476 may provide more AA modification than those for BF light e.g., associated with increased difficulty of providing AA modification to less coherent (e.g., associated with scattering from the inspection object) DF light Δ20.

FIG. 5 is a simplified schematic of a pupil divider 558, according to some embodiments of the disclosure.

Inspection light 524 (e.g. corresponding to inspection light 124 FIG. 1A) arrives to pupil divider 558, where portions of the beam 524 undergo different optical paths also termed “sub-apertures”, where the different optical paths each provide different delays to the portion of light passing therethrough e.g., the different optical paths having different lengths through material 502, 504 of the pupil divider. Where the material is a material which is transparent (e.g., to wavelengths of inspection light 524) while retarding of the light, the amount of retardation associated with the thickness of the material through which the light passes. In some embodiments, portions 502, 504 include (e.g., are formed of) fused silica.

In some embodiments, the different length optical paths through material of pupil divider 558 are provided by a shape of portions 502, 504 of pupil divider e.g., where different optical paths are provided by different thicknesses of part/s of portion/s 502, 504. In some embodiments, pupil divider 558 includes one or more stepped elements 502, 504. In the embodiment illustrated in FIG. 5, stepping is in two perpendicular directions to provide an array 506 of different optical paths or sup-apertures.

Where thickness 510 of steps of portion 502 are associated with retarding light by Δ₁ and thicknesses 512 of steps of portion 504 are associated with retarding light by Δ₂.

FIG. 5 illustrates the different delays for different beam portions, where, for example, beam portion 582 is taken as having no delay, beam portion 584 has a delay of Δ₁, beam portion 586 has a delay of Δ₂, and beam portion 588 has a delay of Δ₁+Δ₂.

In some embodiments, step sizes 510, 512 are configured to provide optical paths where the outputted light is non-coherent e.g., to prevent interference between the light of the different sub-apertures. In some embodiments, a difference between optical path length of any two paths is longer than the coherence length of the light source (e.g., light source 102 FIG. 1A).

In an exemplary embodiment, step size 510 is 2 mm, and step size 512 is 2.2 mm, e.g., for a laser wavelength of 80 microns. Where different step sizes 510, 512 in different directions are associated with different smear (e.g., anti-aliasing effects) in the different directions of the different step sizes. In some embodiments, for example, where uniform anti-aliasing is required in two directions, step sizes for the two portions 502, 504 are the same (e.g., having about the same step size).

### General

As used within this document, the term “about” refers to ±20%

The terms “comprises”, “comprising”, “includes”, “including”, “having” and their conjugates mean “including but not limited to”.

The term “consisting of” means “including and limited to”.

As used herein, singular forms, for example, “a”, “an” and “the” include plural references unless the context clearly dictates otherwise.

Within this application, various quantifications and/or expressions may include use of ranges. Range format should not be construed as an inflexible limitation on the scope of the present disclosure. Accordingly, descriptions including ranges should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within the stated range and/or subrange, for example, 1, 2, 3, 4, 5, and 6. Whenever a numerical range is indicated within this document, it is meant to include any cited numeral (fractional or integral) within the indicated range.

It is appreciated that certain features which are (e.g., for clarity) described in the context of separate embodiments, may also be provided in combination in a single embodiment. Where various features of the present disclosure, which are (e.g., for brevity) described in a context of a single embodiment, may also be provided separately or in any suitable sub-combination or may be suitable for use with any other described embodiment. Features described in the context of various embodiments are not to be considered essential features of those embodiments, unless the embodiment is inoperative without those elements.

Although the present disclosure has been described in conjunction with specific embodiments thereof, it is evident that many alternatives, modifications, and variations will be apparent to those skilled in the art. Accordingly, this application intends to embrace all such alternatives, modifications and variations that fall within the spirit and broad scope of the appended claims.

All references (e.g., publications, patents, patent applications) mentioned in this specification are herein incorporated in their entirety by reference into the specification, e.g., as if each individual publication, patent, or patent application was individually indicated to be incorporated herein by reference. Citation or identification of any reference in this application should not be construed as an admission that such reference is available as prior art to the present disclosure. In addition, any priority document(s) and/or documents related to this application (e.g., co-filed) are hereby incorporated herein by reference in its/their entirety.

Where section headings are used in this document, they should not be interpreted as necessarily limiting.

1. A wafer inspection tool comprising:
an illumination system providing ultraviolet illumination light with wavelengths λ below 300 nm and configured to direct light towards an object to be inspected;
a detector array having a pixel pitch;
one or more anti-aliasing (AA) elements;
an objective having a numerical aperture (NA) and configured to collect light provided by said illumination system and returning from a plurality of field points on the object and to onwardly transmit a light beam formed from the returning light which has been collected towards said detector array via said one or more AA elements;
a processor configured to:
receive imaging requirements;
control a NA of said objective;
control, when said pixel pitch is larger than λ/(4*NA), position of said one or more anti-aliasing elements, based on said pixel pitch, said NA, and said imaging requirements.

2. The wafer inspection tool according to claim 1, wherein said objective comprises a plurality of optical elements mechanically supported by a turret and one or more actuators configured to position said optical elements;
wherein said processor is configured to control said NA of said objective by sending control signals to said one or more actuators to one or more of:
selectively position one or more of said plurality of optical elements in an optical path of said objective; and
selectively position said one or more of said plurality of optical elements along said optical path of said objective.

3. The wafer inspection tool according to claim 2, comprising one or more anti-aliasing AA element actuators, wherein said processor is configured to control position of said one or more AA elements by sending control signals to said one or more AA element actuators.

4. The wafer inspection tool according to claim 3, wherein said control of position is of whether said one or more AA elements are in an optical path of said returning light.

5. The wafer inspection tool according to claim 3, wherein said control of position is to move said one or more AA elements sufficiently rapidly with respect to an image exposure time that the movement provides image smear.

6. The wafer inspection tool according to claim 5, wherein said one or more AA elements comprise one or more of said detector array, a platform supporting said object, and one or more optical element in an optical path of said returning light.

7. The wafer inspection tool according to claim 1, wherein at least one of said one or more AA elements is positioned at a image plane of said returning light; and
wherein said detector array is positioned behind said one or more anti-aliasing elements, at a defocusing distance from said image plane.

8. The wafer inspection tool according to claim 7, wherein said one or more AA elements comprises a Damman grating.

9. The wafer inspection tool according to claim 8, wherein said processor is configured to determine said defocusing distance by:
determining output of said Damman grating at far field, based on physical specifications of said Damman grating;
modeling near field behavior of the Damman grating, based on said output; and
selecting said defocusing distance, using said modeling and said imaging requirements.

10. The wafer inspection tool according to claim 7, wherein said one or more AA elements comprises one or more savart plate.

11. The wafer inspection tool according to claim 7, wherein said one or more AA elements comprises a fluorescent plate.

12. The wafer inspection tool according to claim 1, wherein at least one of said one or more AA elements is positioned at a pupil of said wafer inspection tool.

13. The wafer inspection tool according to claim 12, wherein said at least one AA element positioned at said pupil comprises a pupil divider configured to divide said returning light into portions having different delays.

14. The wafer inspection tool according to claim 12, wherein said at least one AA element positioned at said pupil comprises one or more of a savart plate, and a Wollaston prism.

15. The wafer tool according to claim 1, wherein said processor is configured to:
control an effective pixel pitch of said detector array; and
control said position of said one or more anti-aliasing elements based on said effective pixel pitch.

16. The wafer inspection tool according to claim 15, comprising an imaging lens arrangement configured to focus and direct said light beam towards said detector array.

17. The wafer inspection tool according to claim 16, wherein said objective comprises at least one objective lens and a telescope.

18. A method of wafer inspection comprising:
receiving a pixel pitch of a detector array of a wafer inspection tool and imaging requirements for inspection of an object;
selecting a numerical aperture (NA) of a wafer inspection tool by controlling one or more actuator of an objective of said wafer inspection tool;
controlling a position of one or more anti-aliasing (AA) element in an optical path of inspection light returning from said inspection object based on said pixel pitch, said NA, and said imaging requirements.

19. The method according to claim 18, wherein said receiving said pixel pitch comprises controlling an effective pixel pitch of said detector array; and
wherein said controlling said position is based on said effective pixel pitch.

20. A wafer inspection tool comprising:
an illumination system providing ultraviolet illumination light with wavelengths λ below 300 nm and configured to direct light towards an object to be inspected;
an objective configured to collect light provided by said illumination system and returning from a plurality of field points on the object and to onwardly transmit and focus a light beam formed from the returning light to a image plane;
a Dammann grating positioned at said image plane; and
a detector array having a pixel pitch and positioned a defocusing distance away from said image plane;
wherein a numerical aperture (NA) of said objective is less than λ/4 of an inverse of said pixel pitch of said detector array.
